(19) United States
(12) Patent Application Publication
(10) Pub. No.: US 2016/0253114 A1
(43) Pub. Date: Sep. 1, 2016

(54) METHOD AND APPARATUS FOR OPTIMIZING DATA STORAGE IN HETEROGENEOUS ENVIRONMENT

(71) Applicant: HITACHI, LTD., Chiyoda-ku, Tokyo (JP)

(72) Inventor: Akira DEGUCHI, Santa Clara (CA)

(21) Appl. No.: 15/032,297

(22) PCT Filed: Nov. 14, 2013
(86) PCT No.: PCT/US13/70147

§ 371 Date: Apr. 26, 2016

(51) Int. Cl. G06F 3/06

(52) U.S. Cl. CPC G06F 3/0619; G06F 3/0689; G06F 3/065; G06F 3/0665

(57) ABSTRACT

Example implementations described herein are directed to a first storage node that provides a virtual volume. The first storage node is configured to execute a first storage function, which accesses the virtual volume. Two or more second storage nodes configured to provide, in one or more volumes, storage capacity to the virtual volume. At least one of the second storage nodes is configured to execute a second storage function, which accesses the one or more volumes. A management server compares the first storage function and the second storage function and sends an instruction to suspend the first storage function or the second storage function based on a result of the comparison.

### BACKGROUND

1. Field

The example implementations relate to computer systems, storage systems, and, more particularly, to optimization of storage in heterogeneous storage system.

2. Related Art

In the related art, there are methods and apparatuses relating to a distributed storage system, such as secure distributed storage. A storage system may use logical volumes and physical volumes, and data in one volume can be migrated to another volume.

A storage system may involve two or more storage nodes and/or two or more levels of storage configuration. For example, one level of storage configuration may be virtual storage (e.g., software storage, software-defined storage, or cloud storage, collectively referred to as SW storage) that uses storage capacity of the underlying storage devices, volumes, nodes, etc., which is another level of storage configuration.

A storage system often executes one or more storage functionalities, such as duplication, triplication, de-duplication, compression, data migration, etc. However, a functionality that is applied to a storage system can cause undesired effects if the same or another functionality is applied to the storage system.

### SUMMARY

Aspects of the example implementations described herein include a system, including a first storage node that provides a virtual volume. The first storage node is configured to execute a first storage function, which accesses the virtual volume. Two or more second storage nodes configured to provide, in one or more volumes, storage capacity to the virtual volume. At least one of the second storage nodes is configured to execute a second storage function, which accesses the one or more volumes. A management server compares the first storage function and the second storage function and sends an instruction to suspend the first storage function or the second storage function based on a result of the comparison.

Aspects of the example implementations include a computer program for a management server in communication with a first storage node and two or more second storage nodes, which may include code for comparing a first storage function and a second storage function; and code for sending an instruction to suspend the first storage function or the second storage function to a first storage node or at least one of two or more second storage nodes based on a result of the comparison. The first storage node may be configured to provide a virtual volume and apply the first storage function to the virtual volume; and the second storage nodes are configured to provide a volume to the first storage node, the volume provides storage capacity to the virtual volume provided by the first storage node, and the at least one of the second storage nodes are configured to apply the second storage function to the volume.

Aspects of the example implementations include a method for a management server in communication with a first storage node and two or more second storage nodes, the process may include comparing a first storage function and a second storage function; and sending an instruction to suspend the first storage function or the second storage function to a first storage node or at least one of two or more second storage nodes based on a result of the comparison. The first storage node is configured to provide a virtual volume and apply the first storage function to the virtual volume; and the second storage nodes are configured to provide a volume to the first storage node, the volume provides storage capacity to the virtual volume provided by the first storage node, and the at least one of the second storage nodes are configured to apply the second storage function to the volume.

### BRIEF DESCRIPTION OF THE DRAWINGS

FIG. 1 shows an example computer system in accordance with one or more example implementations.

FIG. 2 shows an example node in accordance with one or more example implementations.

FIG. 3 shows an example storage system in accordance with one or more example implementations.

FIG. 4 shows SW storage examples in accordance with one or more example implementations.

FIG. 5 shows example program and example memory of a management server in accordance with one or more example implementations.

FIG. 6 shows example program and example memory of a SW storage in accordance with one or more example implementations.

FIG. 7 shows an example storage node table in accordance with one or more example implementations.

FIG. 8 shows an example triplication table in accordance with one or more example implementations.

FIG. 9 shows an example storage program in accordance with one or more ex ample implementations.

FIG. 10 shows example storage control information in accordance with one or more example implementations.

FIG. 11 shows SW storage examples in accordance with one or more example implementations.

FIG. 12 shows an example process to add new storage capacity in accordance with one or more example implementations.

FIG. 13 shows an example functionality suspension process in accordance with one or more example implementations.

FIG. 14 shows an example storage configuration change process in accordance with one or more example implementations.

FIG. 15 shows an example implementation of an I/O program in accordance with one or more example implementations.

FIG. 16 shows another example functionality suspension process in accordance with one or more example implementations.

FIG. 17 shows an example of the triplication program in accordance with one or more example implementations.

FIG. 18 shows another SW storage example in accordance with one or more example implementations.

FIG. 19 shows another example functionality suspension process in accordance with one or more example implementations.

FIG. 20 shows an example de-duplication suspension table in accordance with one or more example implementations.

FIG. 21 shows an example de-duplication program in accordance with one or more example implementations.

FIG. 22 shows another SW storage example in accordance with one or more example implementations.

FIG. 23 shows an example tier control program in accordance with one or more ex ample implementations.

### DETAILED DESCRIPTION

A storage system may include high performance storage devices and systems (e.g., enterprise storage system, etc.) and standard-performance or general storage devices and systems (e.g., commodity server, etc.) to provide physical storage capacity. A storage system may include virtual storage (e.g., software storage, software-defined storage, cloud storage, etc., collectively referred to as software storage or SW storage).

When a storage system (e.g., one that includes SW storage and enterprise storage, etc.) applies storage functionalities, problems may occur. For example, the SW storage executes a remote copy function for disaster recovery. The enterprise storage, which provides the underlying physical storage capacity to the SW storage, also executes a remote copy function for disaster recovery. The effect is that one of the two remote copy operations unnecessarily consumes computing resources (e.g., CPU and network resources). Another example is that a SW storage may perform data triplication for data protection. The underlying storage (e.g., enterprise storage system) may also protect data by using RAID (redundant arrays of independent disks). The double protection is superfluous and resources are unnecessary consumed.

Similarly, when a SW storage performs data triplication to the underlying storage systems, if one or more of the underlying storage systems perform data de-duplication, the results from data triplication operation are canceled or voided by the data de-duplication operation.

Example implementations herein describe avoidance or prevention of performance decrease or degradation by, for example, suspension of storage functionalities or modification of the application of storage functionalities. Decrease in performance can be prevented by, for example, avoiding simultaneous application of storage functionalities, where the result of one functionality duplicates or negates the effect of another functionality.

The following detailed description provides further details of the figures and example implementations of the present application. Reference numerals and descriptions of redundant elements between figures are omitted for clarity. Terms used throughout the description are provided as examples and are not intended to be limiting. For example, use of the term “automatic” may involve fully automatic or semi-automatic implementations involving user or administrator control over certain aspects of the implementation, depending on the desired implementation of one of ordinary skill in the art practicing implementations of the present application.

The subject matter herein is described using example implementations and is not limited to the example implementations. In actual implementations, there may be fewer, more, or different components, acts, and/or elements as described in an example implementation. In the form of a process or method (e.g., a computer, device, or system implemented process), actual implementations may include fewer, more, or different operations or operations in orders different from that described in a process.

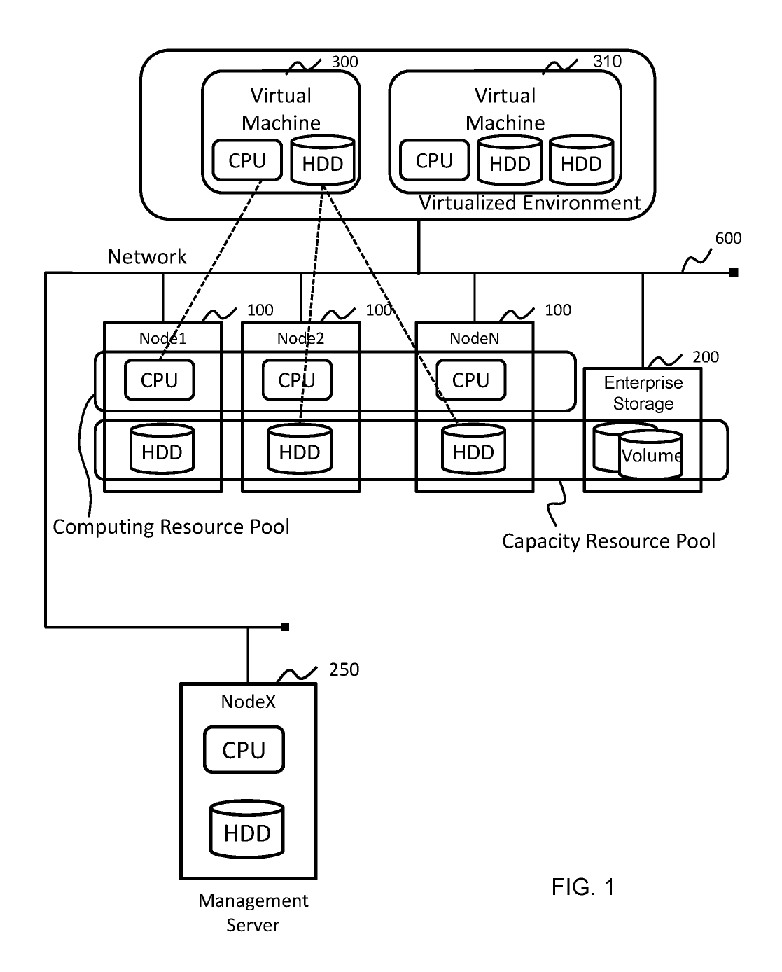

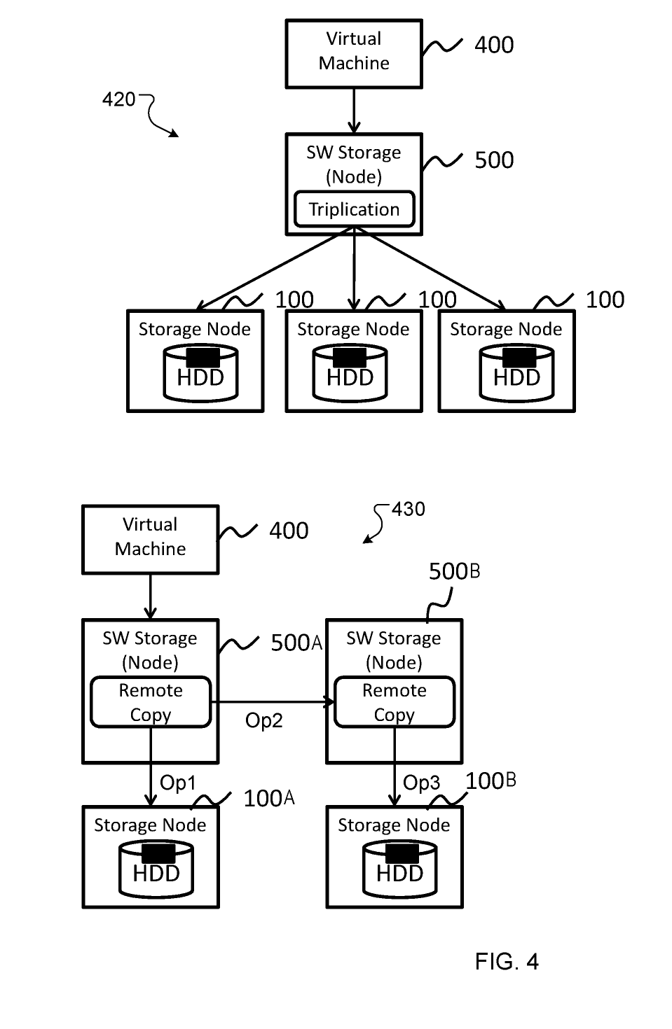

FIG. 1 shows an example computer system in accordance with one or more example implementations. The example computer system includes, for example, one or more devices or nodes 100 and one or more storage systems, such as an enterprise storage system 200. There may be zero, one, or more management servers 250. In some implementations, some or all the functions of a management server 250 may be provided by one or more nodes 100. For example, in an implementation where a node 100 also functions as management server 250, there is no separate management server 250. A node 100 may be configured to function as a storage node, e.g., a SW storage node 500, shown in FIG. 4.

Resources, such as processor resources and storage resources may be provided to one or more devices, systems, computers, and/or virtual machines, such virtual machine (VM) 300 and VM 310. One or more virtual machines may be created using one or more nodes 100 and/or enterprise storage system 200. A virtual central processing unit (CPU) of a VM may be provided using the computing resource pool, formed using the CPUs of one or more nodes 100 and/or the one or more processors (not shown) of enterprise storage system 200. A virtual volume or HDD of a VM (e.g., the HDD of virtual machine 300) may be provided using the capacity resource pool, formed using the storage devices (referred to as HDD) of one or more nodes 100 and/or the volumes of enterprise storage system 200.

Nodes, machines, and systems 100, 200, 250, 300, and 310 may communicate using one or more communicative connections, such as network 600.

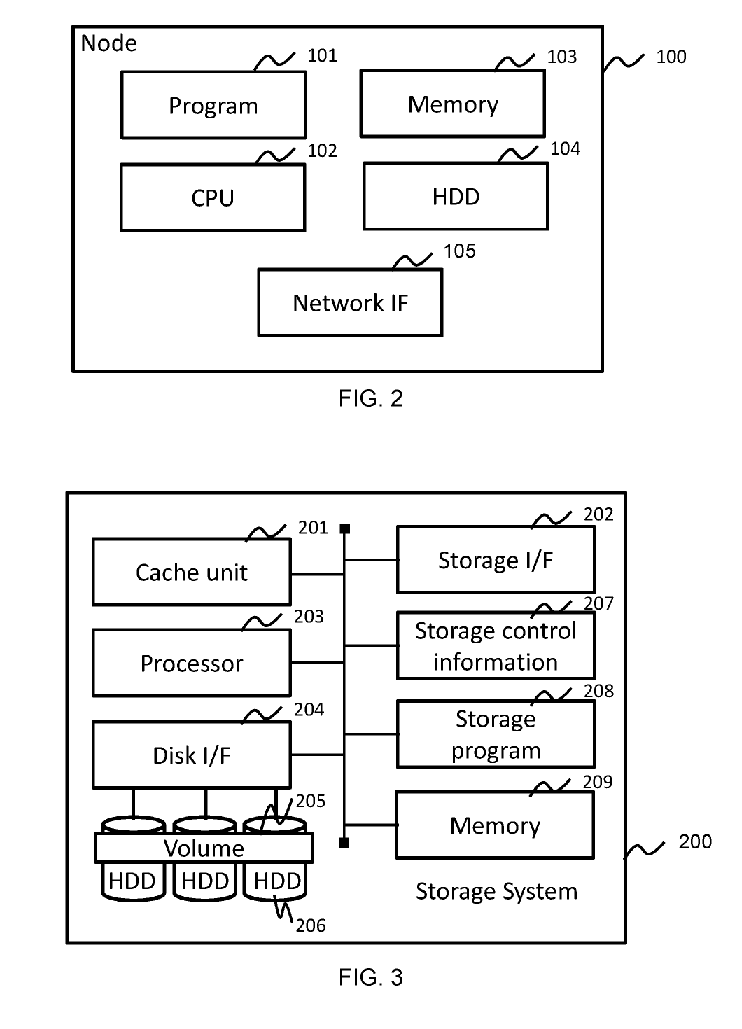

FIG. 2 shows an example node in accordance with one or more example implementations. The node 100 may execute any operating system, (OS, not shown). Node 100 includes, for example, at least one processor or CPU 102, memory (e.g., dynamic random access memory, or DRAM) 103, and storage, such as hard disk drive (HDD) 104. Server 100 may execute one or more applications and programs (referred to as program 106). Program 106 may be stored in a storage medium and/or loaded into memory 103. The CPU 102 and memory 103 may function together as a controller for controlling the functions of node 100. The storage medium may take the form of a computer readable storage medium or can be replaced by a computer readable signal medium as described below.

A node 100 may be configured as a management server 250 or a storage node (e.g., SW storage node 500, FIG. 4). A node 100 may be communicatively coupled to other nodes, machines, and systems 100, 200, 250, 300,310, and 500, etc. using communication or network interface (I/F) 105, for example, via network 600.

FIG. 3 shows an example storage system in accordance with one or more example implementations. Storage system 200 (e.g., enterprise storage) includes, for example, cache unit 201, a communication interface (e.g., storage I/F 202), at least one processor 203, disk interface (I/F) 204, at least one volume 205, at least one physical storage device 206, storage control information 207, storage program 208, and memory 209. Components 201-208 of storage system 200 are examples of components. In some implementations, a storage system may include fewer, more, or different components.

Storage I/F 202 may be used for communicating with, for example, nodes 100 and 250 and machines 300 and 310 via, for example, network 600. Processor 203 may execute a wide variety of processes, software modules, and/or programs (collectively referred to as programs), such as read processing program, write processing program, and/or other programs. Processor 203 may execute programs stored in storage program 208 and/or retrieved from other storages (e.g., storage medium, not shown).

The above described programs (e.g., storage program 208), other software programs (e.g., one or more operating systems), and information (e.g., storage control information 207) may be stored in memory 209 and/or a storage medium. A computer program or OS, as codes or instructions, may be executed by processor 203 and/or CPU 102 of node 100, FIG. 2 to perform one or more computer-implemented processes and methods. A storage medium may be in a form of a computer readable storage medium, which includes tangible media such as flash memory, random access memory (RAM), hard disk drive (HDD), SSD, or the like. Alternatively, a computer readable signal medium (not shown) can be used, which can be in the form of carrier waves. The memory 209 and the processor 203 may work in tandem with other components (e.g., hardware elements and/or software elements) to function as a controller for the management of storage system 200.

Processor 203, programs (e.g., storage program 208), and/or other services accesses a wide variety of information, including information stored in storage control information 207. Disk I/F 204 is communicatively coupled (e.g., via a bus and/or network connection) to at least one physical storage device 206, which may be a HDD, a solid state drive (SSD), a hybrid SSD, digital versatile disc (DVD), and/or other physical storage device (collectively referred to as HDD 206). In some implementations, cache unit 201 may be used to cache data stored in HDD 206 for performance boost.

In some implementations, at least one HDD 206 can be used in a parity group. HDD 206 may be used to implement high reliability storage using, for example, redundant arrays of independent disks (RAID) techniques. At least one volume 205 may be formed or configured to manage and/or store data using, for example, at least one storage region of one or more HDD 206.

FIG. 4 shows SW storage examples in accordance with one or more example implementations. One or more virtual storages, such as logical storages, software defined storages, or software storages (collectively referred to as SW storages) may be created, added, or defined to provide storage to, for example, one or more machines, virtual and non-virtual. In the examples of FIG. 4, computing environment 420 shows a SW storage 500 provides storage to VM 400. SW storage 500 may be defined using one or more storage nodes 100 (e.g., using the storage space or capacity of one or more HDD of storage nodes 100).

The SW storage node 500 can perform one or more storage functionalities, such as triplication for data protection, remote copy for disaster recovery, etc. The triplication operation is shown in environment 420. By performing data triplication, SW storage 500 sends three copies of data for storing in the storage nodes 100. The black rectangle by the HDD of each node 100 represents a copy of the same data. SW storage 500 protects the data accessed and stored by VM 400 (i.e., VM 400 does not need to store another copy of its data elsewhere and is still protected from, for example, a storage failure). In environment 420, if the storage nodes 100 perform any operation that, for example, negates the triplication operation, such as a de-duplication operation (e.g., reducing three copies of data to a single copy), the triplication operation or the de-duplication operation, which consume system resources, is wasted and unnecessary and negatively affect system performance. Techniques are described below to eliminate, suspend, or otherwise cancel one of the triplication and de-duplication operations.

Environment 430 shows a VM 400 communicatively connected to SW storage 500A, which uses the services and storage of storage node 100A. SW storage 500A may perform a remote copy functionality to SW storage 500B, which uses the services and storage of storage node 100B. The remote copy operations Op1 (from 500A to 100A), Op2 (from 500A to 500B), and Op3 (from 500B to 100B) result in two copies of the same data stored in nodes 100A and 100B (each is shown with a black rectangle by the HDD of 100A and 100B). If any of node 100A and 100B performs any data protection, such as creating another copy of the same data somewhere, the effort of that operation will be wasted and unnecessary. Techniques are described below to eliminate, suspend, or otherwise cancel one or more of the remote copy operations.

A “storage functionality” or “functionality” associated with a storage volume, as used herein, refers to any program, process, function, operation, series of operations, etc. that are executed in association with any data stored in the storage volume. A “storage functionality” or “functionality” is not a read/write or I/O request from a server.

SW storage nodes 500, 500A, and 500B are described in the example environments 420 and 430. Storage systems and environments may be implemented without any SW storage (e.g., as in FIG. 1). If a SW storage node is implemented, it can be implemented using a separate device, system, or node, or it can be implemented on top of one or more other devices, systems, or nodes, such as nodes 100, 200, and/or 250, FIG. 1.

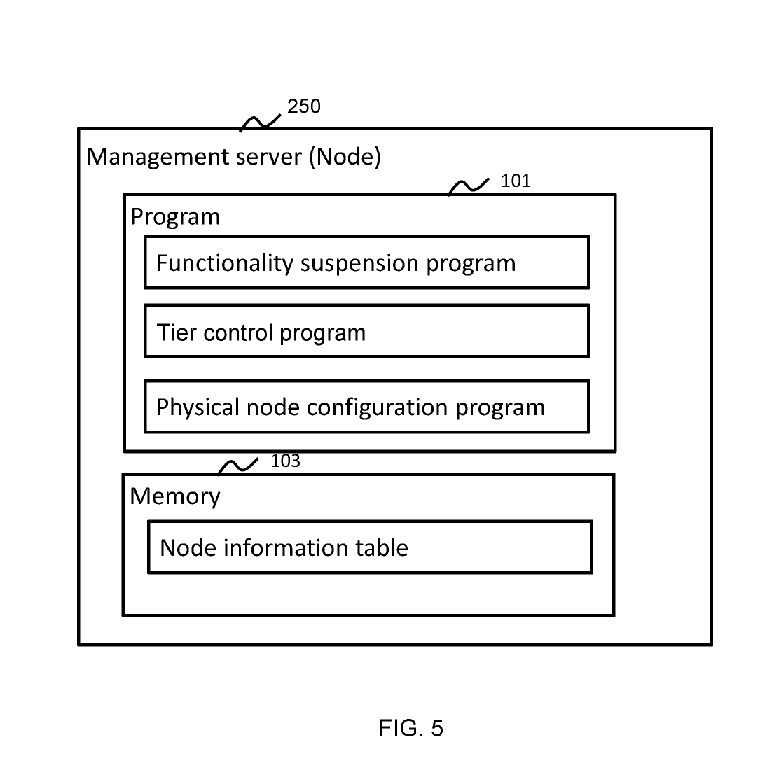

FIG. 5 shows example program and example memory of a management server in accordance with one or more example implementations. A node configured as a management server 250, FIG. 1, may execute programs or functionalities, such as a functionality suspension program, a tier control program, physical node configuration program, etc. A management server may access (and may store in its memory) node information (e.g., in a table). The node information includes, for example, node ID, HDD capacity, the number of CPUs associated with a node, the types of CPUs, error information, etc. that facilitate the functions of a management server.

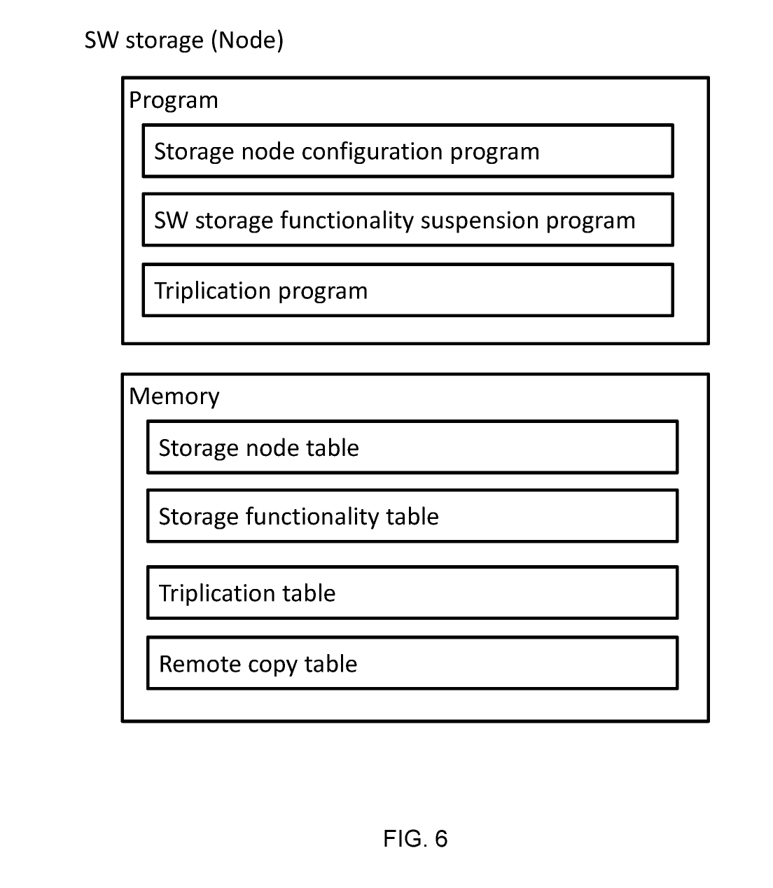

FIG. 6 shows example program and example memory of a SW storage in accordance with one or more example implementations. A SW storage node may be a virtual node or a physically node. A SW node may execute programs or functionalities, such as storage node configuration program, SW storage functionality suspension program, triplication program, etc.

A SW storage node may access (and may store in its memory) information (e.g., in a table form). The information includes, for example, a storage node table, a storage functionality table, a triplication table, a remote copy table, etc. The information or tables may be used to manage source storage area information, destination storage area information, destination storage node information, copy status, etc.

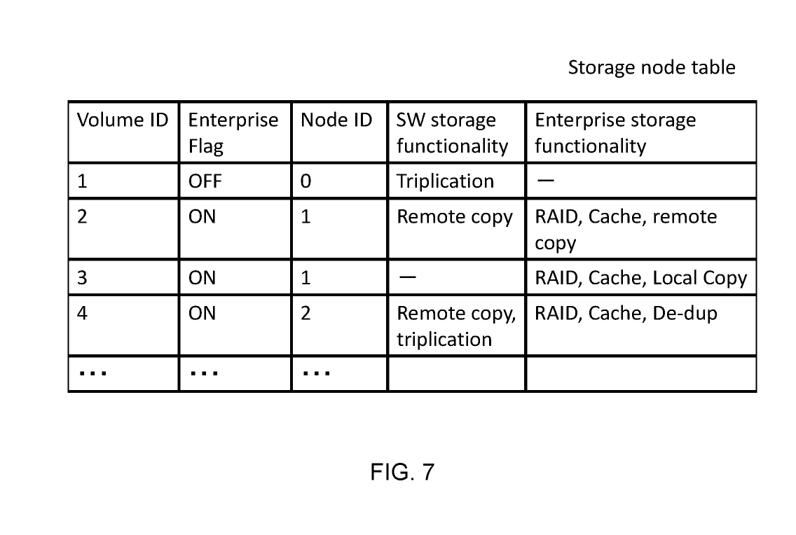

For example, the storage node table (described further in FIG. 7, below) may be used to manage the node information constituting a SW storage node. The storage functionality table may be used to manage the storage functionalities applicable by the SW storage node. The triplication table may be used to manage triplication operations, such as the combination of triplication, the volumes where data is stored, access priority (e.g., primary flag), etc. The remote copy table may be used to manage the control information about remote copy functionality or operations.

FIG. 7 shows an example storage node table in accordance with one or more example implementations. This table includes information, such as volume ID, enterprise flag, node ID, SW storage functionality, enterprise storage functionality, etc. Volume ID is an identification of a storage area or volume corresponding to HDD or volume in enterprise storage system. Enterprise flag indicates whether a storage area specified by the volume ID is in a higher-performance storage system (e.g., an enterprise storage system). If the value is “ON,” the storage area is in a higher-performance/enterprise storage system. If the value is “OFF,” the storage area is in a commodity storage system (e.g., a node 100).

Node ID is an identification of a node or enterprise storage system. In this example, volume IDs 2 and 3 are associated with node ID 1. An enterprise flag with the value of “ON” associated with volume IDs 2 and 3 indicates that volume 2 and 3 are provided by the same higher-performance or enterprise storage system. SW storage functionality indicates which functionality or functionalities are associated with and scheduled to apply (e.g., at appropriate times) to the volume identified by the volume ID (on the same line). In this example, triplication is associated with volume 1. Enterprise storage functionality indicates which functionality or functionalities are associated with and scheduled to apply (e.g., at appropriate times) to the volume identified by the volume ID (on the same line). Enterprise storage functionality is applicable if the enterprise flag is “ON.” In this example, the functionalities of RAID, cache, and remote copy are associated with volume 2.

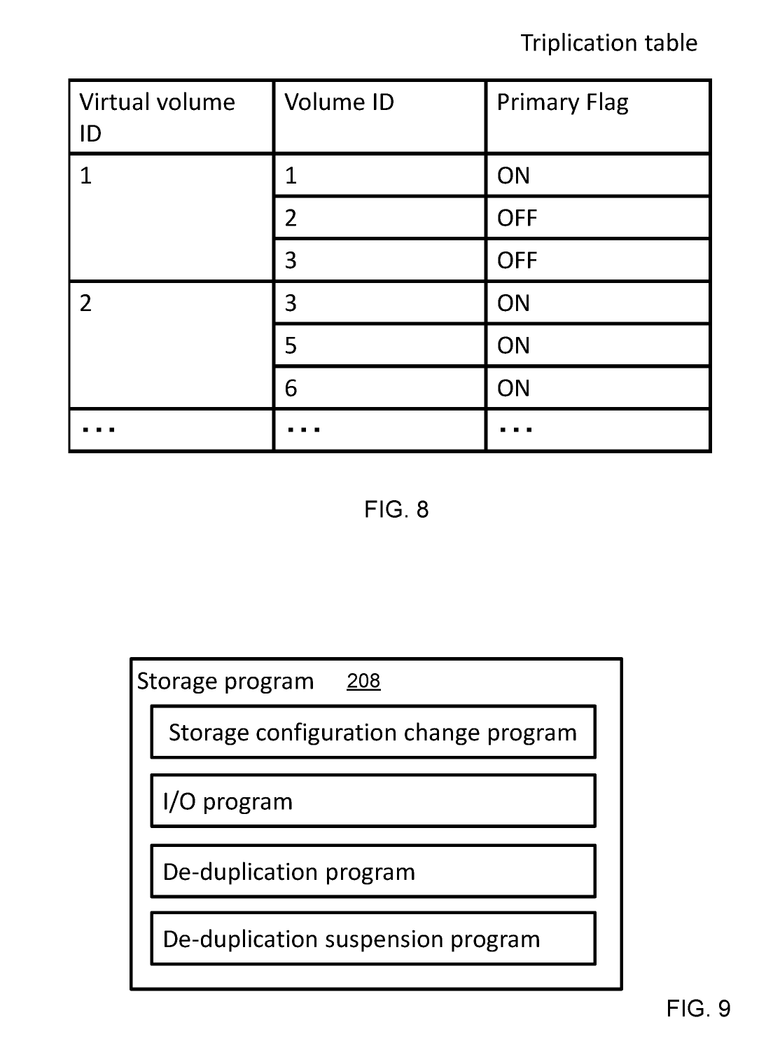

FIG. 8 shows an example triplication table in accordance with one or more example implementations. The triplication table contains information, such as the virtual volume ID, volume ID, primary flag, etc. The virtual volume ID is an identification of the virtual volume, which is the storage area provided to the virtual machine. Storage capacity of the virtual volume is provided by one or more volumes (e.g., HDD) of nodes 100 and/or enterprise storage system 200. The volume ID is an identification of the volume or HDD in a node 100 or enterprise storage system 200. In implementations where nodes 100 and enterprise storage system 200 have unique volume IDs, the volume ID alone is suffice to identify a volume. In this example, the volume with ID=3 is configured to provide storage capacity to both virtual volumes 1 and 2.

In implementations where nodes 100 and enterprise storage system 200 do not have unique volume IDs (e.g., volume ID 8 may refer to a volume in two or more nodes or systems), there may be another column of node ID information (not shown).

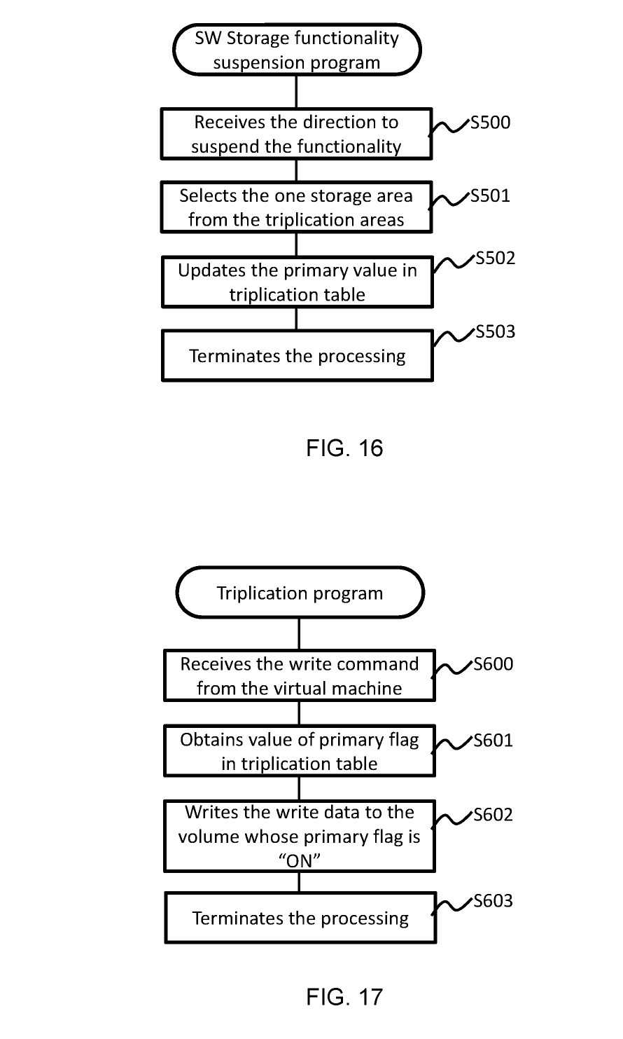

The primary flag, if used, indicates which volume associated with a volume ID is a primary volume or storage. Primary flag is described in FIG. 16 and FIG. 17 below.

In this example, triplication targets are individual storage areas or volumes. In some implementations, the targets may be smaller areas using, for example, LBA (logical block address, etc.). In some implementations, triplication target areas can be calculated or determined (e.g., using predetermined algorithms).

FIG. 9 shows an example storage program in accordance with one or more example implementations. The storage program 208 includes, for example, a storage configuration change program, an 110 program, a de-duplication program, a de-duplication suspension program, etc. These programs are described below.

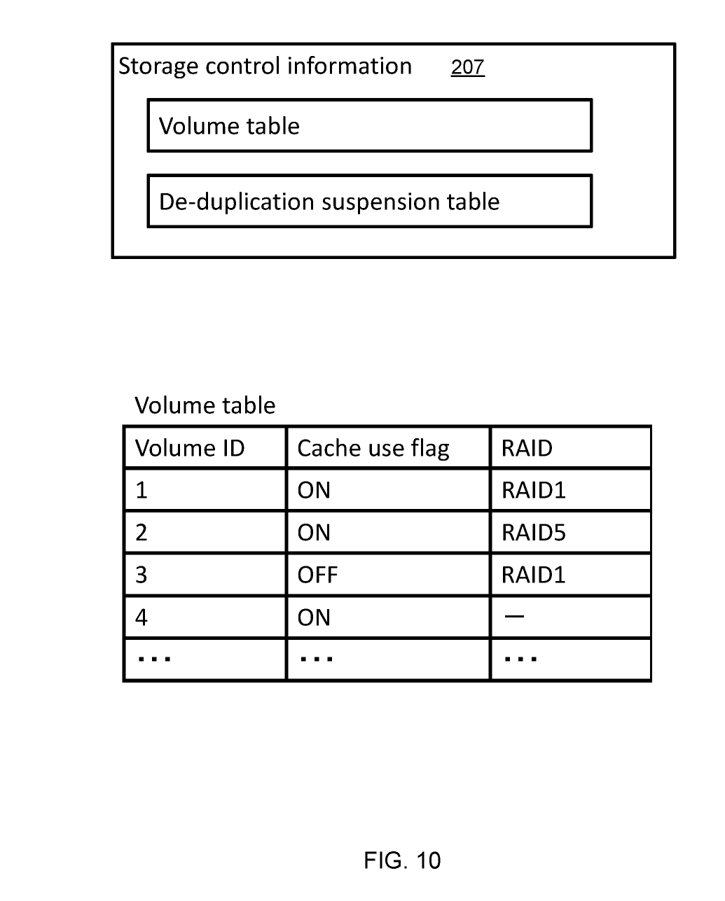

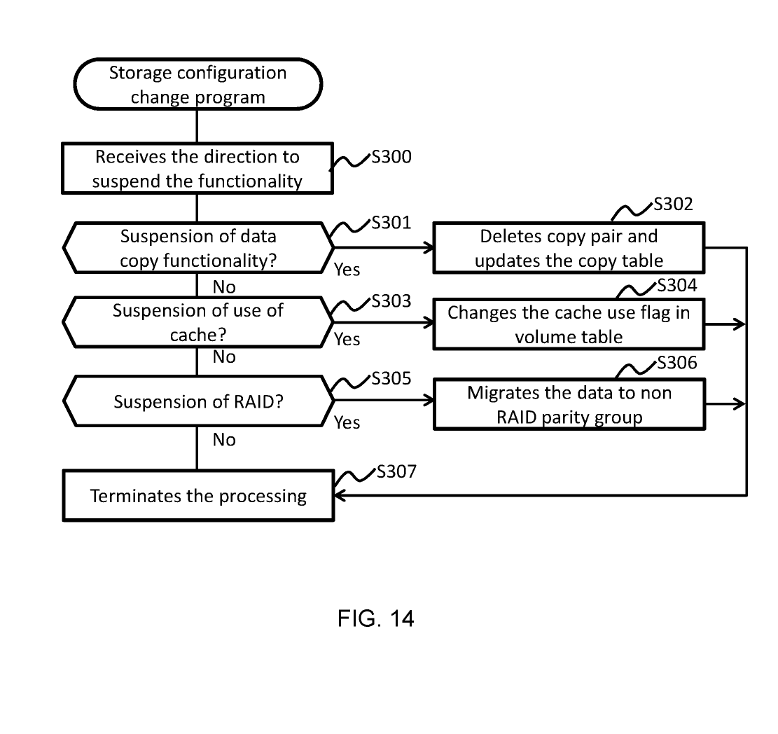

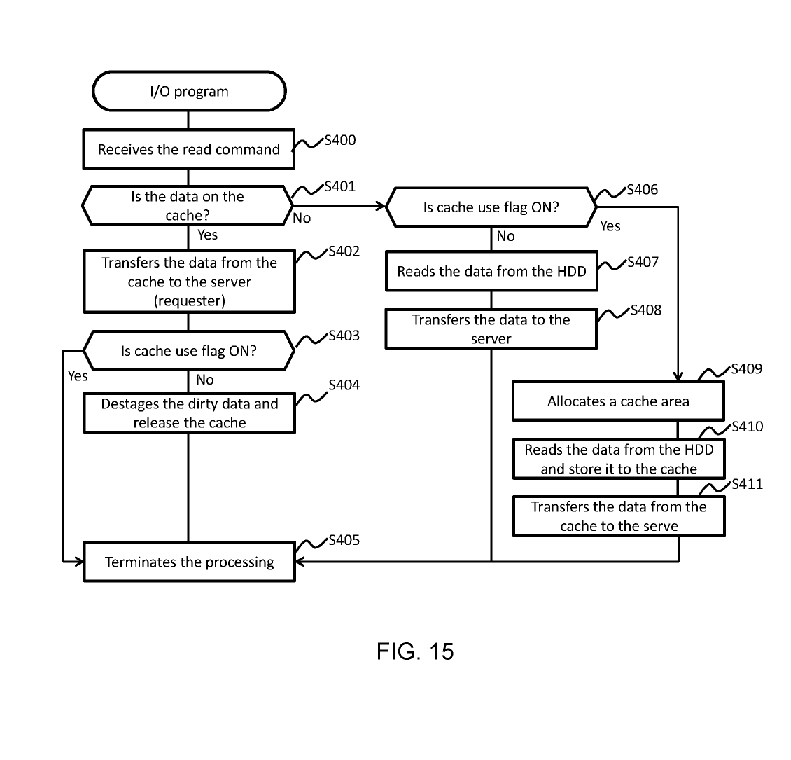

FIG. 10 shows example storage control information in accordance with one or more example implementations. The storage control information 207 includes, for example, a volume table and a de-duplication suspension table. The volume table may be used to manage the volume ID, cache use flag and RAID. The volume ID is used to identify a volume in an enterprise storage system. The cache use flag is described in FIG. 14 and FIG. 15 below. The RAID information is described in FIG. 14 below.

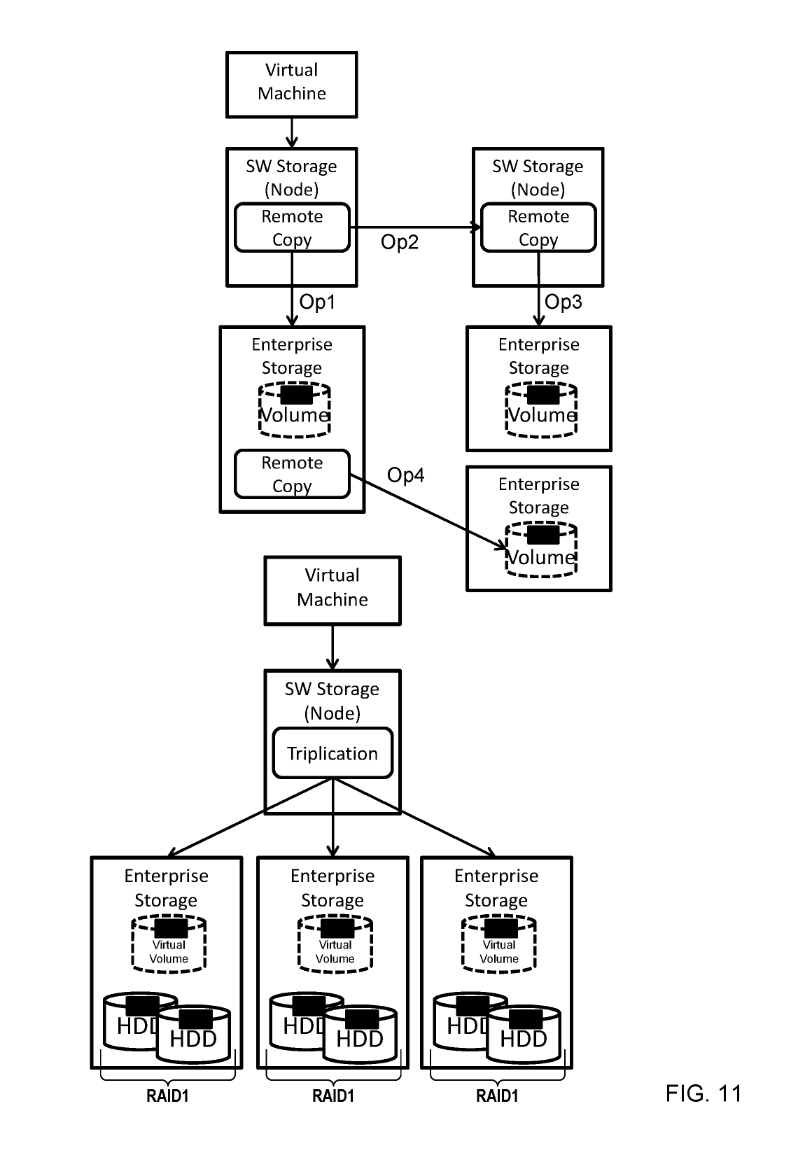

FIG. 11 shows SW storage examples in accordance with one or more example implementations. In FIG. 11, high-performance or enterprise storages are used to provide the underlying physical storage capacity to one or more SW storage nodes. Data written from a machine (e.g., VM) is stored in one or more HDDs in the enterprise storage layer.

The top side of the FIG. 11 shows that SW storage nodes and an enterprise storage system perform remote copy operations. As described in the environment 430 in FIG. 4, operations Op1, Op2, and Op3 create two copies of the same data (each black rectangle represents a copy). The operation Op4 unnecessarily creates a third copy of the same data in a third enterprise storage system.

The remote copy operations Op3 and Op4 result in the same target if the targets of both operations are the same.

The bottom side of FIG. 11 shows that a SW storage performs a triplication operation (e.g., for data protection) to three enterprise storage volumes. One or more of the enterprise storage volumes may be virtually configured (e.g., as virtual volumes, as shown). A virtual enterprise storage volume is supported by one or more actual volumes or storage space (e.g., HDDs, as shown). That is, the data stored in a virtual volume is actually stored in the underlying HDDs or storage space. The underlying HDDs may be, for example, configured with RAID (e.g., RAID1, or mirroring, as shown) for data protection (or configured to perform other data protection operations, such as redundant volumes, triplication, data duplication, etc.). The results, in this example, are six copies of the same data (each black rectangle in a HDD represents a copy), with three copies in each of the enterprise storage system (one virtual copy in the virtual volume and two copies in the mirrored HDDs). Remedies to the example situations in FIG. 11 are described below.

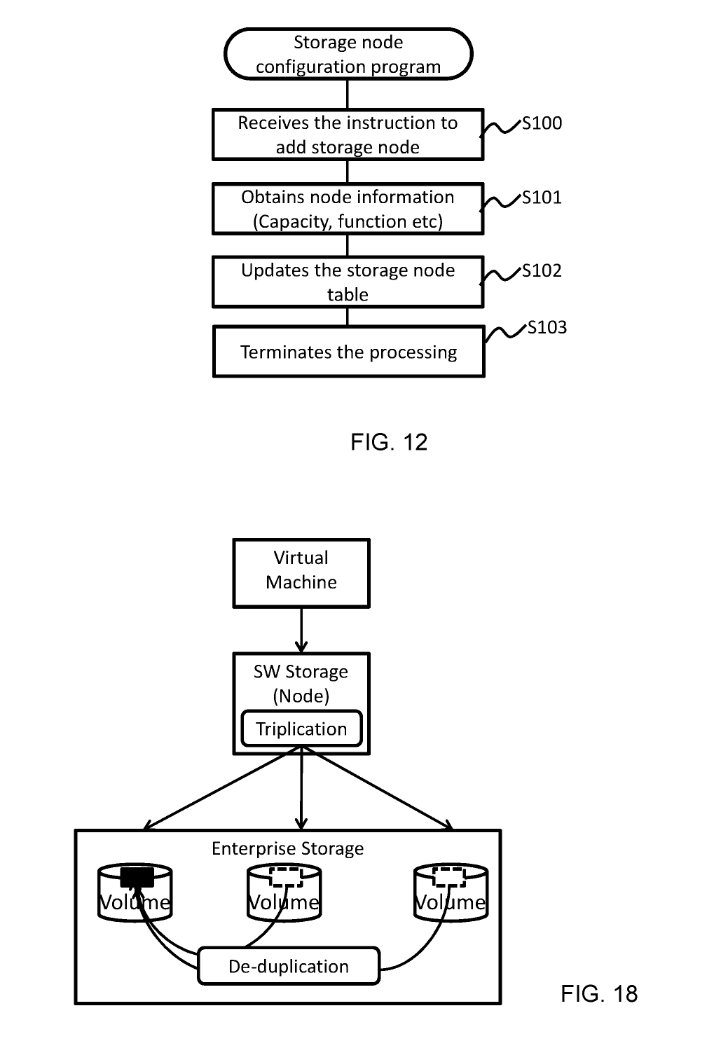

FIG. 12 shows an example process to add new storage capacity in accordance with one or more example implementations. This process, executed with codes or instructions of a storage node configuration program, may be performed by a SW storage node. The storage node configuration program receives the instruction to add a storage node at S100. This program is executed, for example, after an administrator directs the addition of a new storage node, such as via management console or user interface (not shown). At S101, the program obtains or accesses information relating to the specified node (e.g., the storage capacity, storage functionality, etc. of the specified node). At S102, the program updates the storage node table based on information. At S103, the program terminates after all tasks are completed.

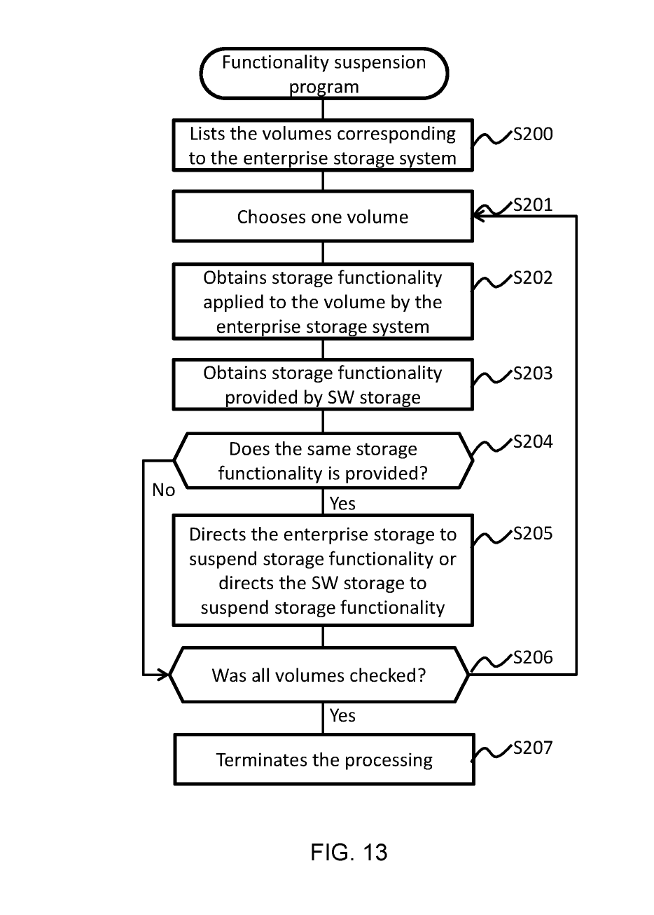

FIG. 13 shows an example functionality suspension process in accordance with one or more example implementations. The functionality suspension program may detect duplicated application of storage functionalities and direct suspension of one or more storage functionalities. This program can be executed in any node (e.g., in a management server) which has access to a SW storage node and its underlying storage node (e.g., enterprise storage node 200).

At S200, the functionality suspension program lists the volumes corresponding to the enterprise storage system or has access to the list. At S201, the program chooses one volume (e.g., any one) from the list. At S202, the program obtains storage functionality applied to the chosen volume by the enterprise storage system. At S203, the program obtains storage functionality provided by the SW storage. This information may be stored in a storage node table. At S204, the program checks whether the same storage functionality, or two functionalities that negate the effort of each other, is applied by both of the SW storage and the enterprise storage system. If the result is “Yes,” at S205, the program directs the enterprise storage to suspend its storage functionality or directs the SW storage to suspend its storage functionality, and the program progresses to S206. If the result at S204 is “No,” the program progresses to S206 where the program checks whether all volumes are processed or checked. If the result at S206 is “No,” the program returns back to the S201 and executes the operations of S202-S206 to process the next volume. If the result at S206 is “Yes,” the program terminates the processing.

FIG. 14 shows an example storage configuration change process in accordance with one or more example implementations. The storage configuration change program stops or suspends a functionality in an enterprise storage system. This program may be stored in a program, unit in the enterprise storage system and executed by the enterprise storage system. This example illustrates, for example, suspension of a copy functionality, a cache functionality, and a RAID functionality (e.g., configuration). The program can be implemented to suspend or stop other functionalities with minimal modification.

At S300, the program receives an instruction, request, or direction to suspend a functionality. At S301, program determines whether the target functionality is a copy functionality, such as a remote copy or in-system copy. If the result is “Yes,” at S302, the program, deletes a second copy of data and updates the copy table, such as a remote copy table. If the result at S301 is “No,” at S303, the program checks whether the target functionality is a cache configuration. If the result is “Yes,” at S304, the program changes the cache use flag, for example, in a volume table to “OFF” or “Disabled”. The flag is described further in FIG. 15 below.

If the result at S303 is “No,” the program checks whether the target functionality is RAID, at S305. If the result is “Yes,” the program, at S306, migrates data stored in the RAID parity group to non-RAID parity group using any available data migration method. The program terminates at S307.

FIG. 15 shows an example implementation of an I/O program in accordance with one or more example implementations. This program checks the cache use flag and decides whether to use the cache unit 201. This program may be stored in a program unit in an enterprise storage system and executed by the enterprise storage system. This example describes read processing (e.g., of a read operation).

The I/O program receives a read command at S400. The program checks whether the requested data is in the cache at S401. If the result is “Yes,” the program transfers the data from the cache to the requester (e.g., a server) at S402. The program checks whether the cache use flag is “ON” at S403. If the flag is “ON,” the program terminates at S405. If the flag at S403 is “OFF,” the program destages the dirty data and releases the cache at S404. If the cached data is clean data (same as the HDD data), the program simply releases the cache.

If at S401, the result is “No,” the program checks whether the cache use flag is ON at S406. If the flag is “OFF,” the program reads the data from the HDD at S407 and transfers it to the requester at S408. If the flash at S406 is “ON,” the program allocates a cache area at S409. The program reads the requested data from the HDD and stores it to the allocated cache area at S410. The program transfers the data (e.g., from the cache) to the requester at S411. The program terminates at S405 after S408 and S411.

FIG. 16 shows another example functionality suspension process in accordance with one or more example implementations. The example SW storage functionality suspension program may be used to suspend a storage functionality in a SW storage node. This program may be executed in the SW storage node to suspend or stop a triplication functionality, a remote copy functionality, etc. The program receives a request, instruction, or direction to suspend a functionality, at S500. The program selects the one volume from three volumes constituting destination of a triplication operation, at S501. The program changes the primary flag for unselected volume to “OFF” in a triplication table described in FIG. 8, at S502. For example, in FIG. 8, when a triplication operation is performed on virtual volume 1, the target volumes are volumes 1, 2, and 3. The program, changes the primary flags for unselected volumes 2 and 3 to “OFF” (volume 1 is selected and the volume and it flag remains “ON” or is changed to “ON”). The program terminates at S503. The primary flag is described in FIG. 17.

FIG. 17 shows an example of the triplication program in accordance with one or more example implementations. Operation of the triplication program is directed or governed by the value of the primary flag. The triplication program receives a write command from a requester (e.g., a virtual machine) at S600. The program obtains the value of the primary flag, for example, in a triplication table, at S601. The program writes the write data to the volume whose primary flag is “ON” at S602, and terminates at S603. If the primary flags of all three volumes (the targets of a triplication operation) are “ON,” the triplication program writes the write data to all three volumes.

FIG. 18 shows another SW storage example in accordance with one or more example implementations. In this example, the enterprise storage has three volumes and schedules to execute de-duplication functionality. The SW storage is configured to perform triplication and uses these three volumes as target volumes. The SW storage writes the data to each of the three volumes, which are located in the same enterprise storage system. The enterprise storage system will eventually detect that the same data are stored in the three volumes and perform a de-duplication. The result is only one copy of the data (e.g., shown in the black box on the left most volume) is stored in the enterprise storage system. The triplication operation at the SW storage and the de-duplication operation perform by the enterprise storage negates each other's effort and result.

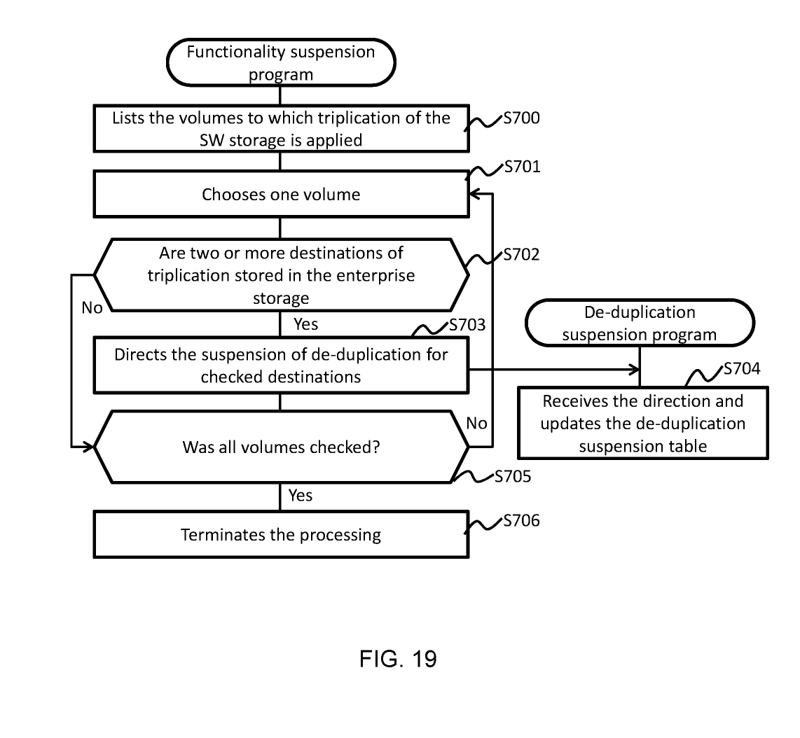

FIG. 19 shows another example functionality suspension process in accordance with one or more example implementations. This program may be executed in a management server or in any node that has access a SW storage node and the underlying nodes, including an enterprise storage system. At S700, the functionality suspension program lists or has access to the list of the volumes used by a triplication operation performed in a SW storage. The program chooses one volume (e.g., any one) from the list at S701. The program checks whether two or more destinations of a triplication operation are corresponding to the same enterprise storage system at S702. If the result is “No,” the program progresses to S705.

If the result at S702 is “Yes,” the program directs the suspension of a de-duplication operation (e.g., a schedule operation) for the checked destinations of the same enterprise storage system at S703. The de-duplication suspension program, which is executed in the enterprise storage system, receives a request, ins traction, or direction from S703 and updates the de-duplication suspension table at S704. The program checks whether all volumes were checked or not at S705. If the result is “No,” the program returns to S701 and performs the operations of S701-705 for the next volume. If the result at S705 is “Yes,” the program terminates at S706.

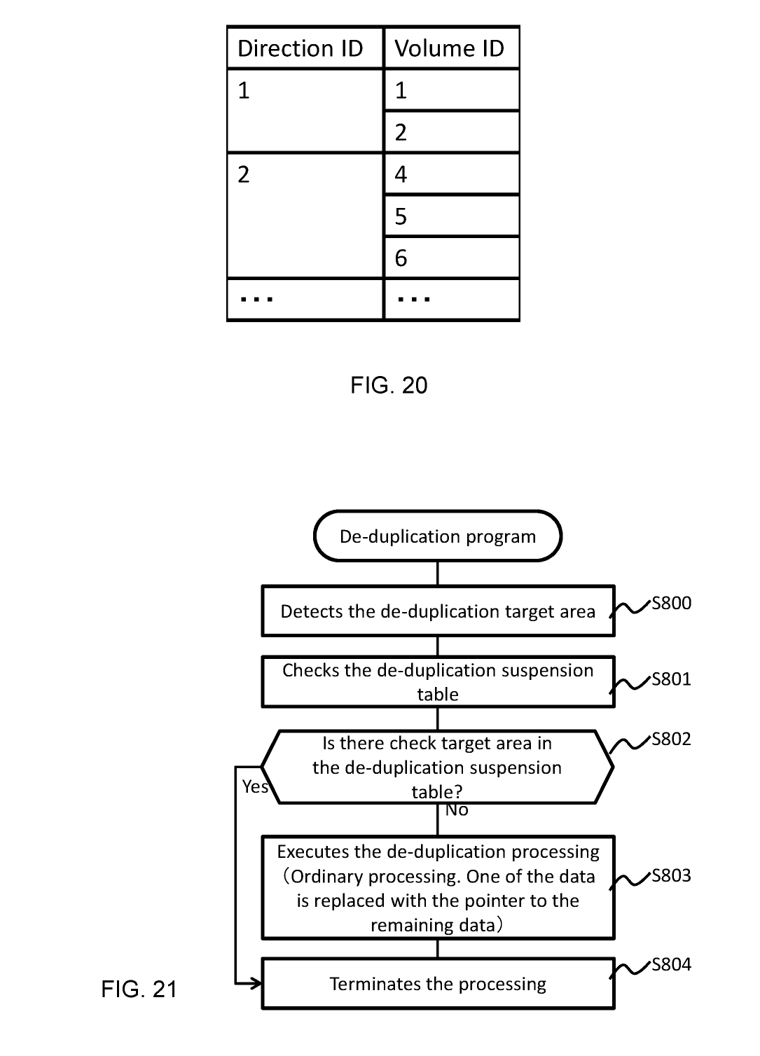

FIG. 20 shows an example de-duplication suspension table in accordance with one or more example implementations. The de-duplication suspension table includes, for example, direction ID and volume ID. The direction ID may indicate a request, instruction, or direction from the functionality suspension program to suspend one or more volumes identified by the volume IDs. The volume ID identifies a volume to which the de-duplication is not applied (e.g., suspended or stopped).

In this example, the de-duplication suspension program has received a request or direction to suspend the de-duplication operation with respect to volumes 1 and 2. The program also receives a request or direction to suspend the de-duplication operation on volumes 4, 5, and 6.

In this example, triplication targets are individual storage volumes or volume units. In some implementations, the targets may be smaller areas using, for example, LBA (logical block address, etc.). In some implementations, triplication target areas can be calculated or determined (e.g., using predetermined algorithms).

FIG. 21 shows an example de-duplication program in accordance with one or more example implementations. The program uses the example de-duplication suspension table. If a volume targeted for de-duplication is in the table, the de-duplication program skips the de-duplication processing or operation. At S800, the program detects or identifies a de-duplication target area or volume. The program checks the de-duplication suspension table at S801. At S802, the program determines if the detected target area is in the de-duplication suspension table. If the result is “Yes,” the program terminates at S804. If the result at S802 is “No,” the program executes the de-dup process at S803, and then terminates at S804. A de-duplication operation may be any available or ordinary de-duplication operation.

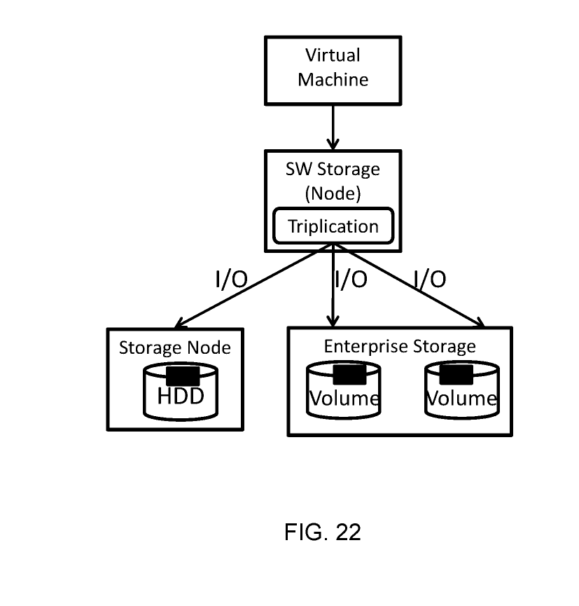

FIG. 22 shows another SW storage example in accordance with one or more example implementations. In this example, the SW storage scheduled to perform triplication operation at some point in time. Two of the destination volumes targeted by the triplication are high-performance volumes (e.g., of an enterprise storage system) and one of the destination volumes is a lower-performance volume (e.g., of a commodity server or node). When the SW storage receives an I/O requests, for example, from the virtual machine, the SW storage issues the requests to any volumes, which causes unstable or fluctuating system performance because the performance of the commodity server is lower than the performance of the enterprise storage system.

In some computing environment, performance tiers are implemented. For example, a higher performance service tier may be provided to one party and a lower performance service tier may be provided to another party. If one or more storage functionalities are suspended, performance tiers may be affected.

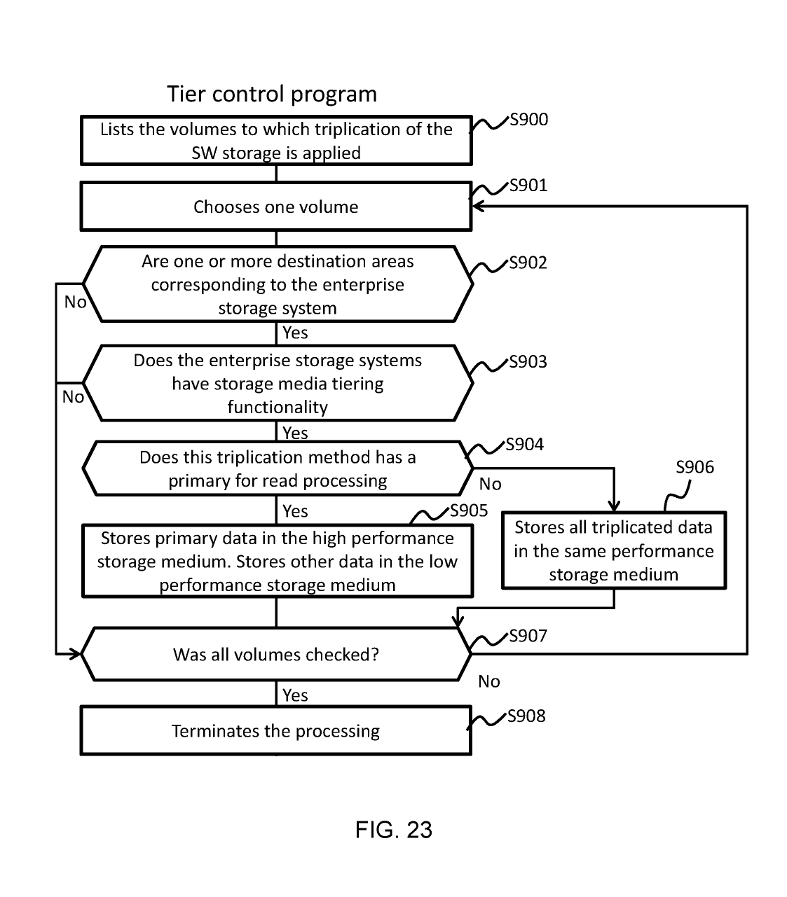

FIG. 23 shows an example tier control program in accordance with one or more example implementations. The example tier control program may be executed to change the storage medium storing the data based on the triplication method. This program may be executed in management server or in any node which has access to a SW storage node and the underlying storage node, including enterprise storage system.

At S900, the program tier obtains or produces a list of volumes to which triplication operation of a SW storage Eire applied. The program chooses one volume (e.g., any one) from the list S901. The program checks whether one or more destination areas are corresponding to the enterprise storage system at S902. If the result is “No,” the program progresses to the S907. If the result at S902 is “Yes,” the program checks whether the enterprise storage system(s) are configured to provide different tiers of storage services at S903. If the result is “No,” the program progresses to S907. If the result at S903 is “Yes,” the program checks whether the triplication operation used a primary area or volume for read operations at S904. If the result is “No,” the program directs the enterprise storage system to store all triplicated data in the same tier of performance storage medium at S906. If the result at S904 is “Yes,” the program, at S905, directs the enterprise storage system to store primary data in a tier of high performance storage medium and store other data (non-primary) data in another tier of low performance storage medium. After S905 and S906, the program progresses to S907, where the program checks whether all volumes have been processed or checked. If the result is “No,” the program returns back to S901 and performs the operation associated with S901-S207 for the next volume. If the result at S907 is “Yes,” the program terminates at S908.

Some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing, ” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a non-transitory medium or a storage medium, or a computer-readable signal medium. Non-transitory media or non-transitory computer-readable media can be tangible media such as, but are not limited to, optical disks, magnetic disks, read-only memories, random access memories, solid state devices and drives, or any other types of tangible media suitable for storing electronic information. A computer readable signal medium may any transitory medium, such as carrier waves. The algorithms and displays presented herein are not inherently related to any particular computer or other apparatus. Computer programs can involve pure software implementations that involve instructions that perform the operations of the desired implementation.

Various general-purpose systems and devices and/or particular/specialized systems and devices may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system, comprising:
a first storage node configured to provide a virtual volume and apply a first storage function to the virtual volume;
a plurality of second storage nodes configured to provide a volume to the first storage node, the volume provides storage capacity to the virtual volume provided by the first storage node, and at least one of the plurality of second storage nodes is configured to apply a second storage function to the volume; and
a management server comprising:
a memory, and
a processor configured to:
compare the first storage function and the second storage function; and
send an instruction to suspend the first storage function or the second storage function to the first storage node or the at least one of the plurality of second storage nodes based on a result of the comparison.

2. The system of claim 1, wherein each of the first storage function and the second storage function is a de-duplication function, a triplication function, a caching function, a RAID function, a remote copying function, or an in-system copying function.

3. The system of claim 1, wherein the first storage function or the second storage function is a caching function, which is suspended in response to the instruction to suspend.

4. The system of claim 1, wherein the first storage function is a triplication function and the first storage node is further comprising another processor configured to:
receive the instruction to suspend the triplication function, which accesses a volume in each of the plurality of second storage nodes;
suspend the triplication function;
assign a primary indicator to a volume in one of the plurality of second storage nodes; and
direct read access or write access to the volume in the one of the plurality of second storage nodes.

5. The system of claim 1, wherein the first storage function and the second storage function are identified based on association information that indicates the first storage node is configured to apply the first storage function to the virtual volume and the at least one of the plurality of second storage nodes is configured to apply the second storage function to the volume.

6. The system of claim 1, wherein the first storage function is a triplication function and the second storage function is a de-duplication function, which is suspended in response to the instruction to suspend.

7. The system of claim 1, wherein the first storage function is a triplication function and is suspended in response to the instruction to suspend, and the processor of the server is further configured to:
determine that volumes in the plurality of second storage nodes are configured to operate in two or more tiers comprising a first tier of performance and a second tier of performance, which is higher than the first tier of performance;
assign a primary storage to a volume in one of the plurality of second storage nodes associated with the second tier of performance upon a determination that the triplication function uses the primary indicator; and
direct read access or write access associated with the second tier of performance to the primary storage.

8. A method for a management server in communication with a first storage node and a plurality of second storage nodes, the method comprising:
providing, by the first storage node, a virtual volume;
applying, by the first storage node, a first storage function to the virtual volume;
providing, by the plurality of second storage nodes, a volume to the first storage node, the volume provides storage capacity to the virtual volume provided by the first storage node;
applying, by at least one of the plurality of second storage nodes, a second storage function to the volume;
comparing, by the management server, the first storage function and the second storage function; and
sending, by the management server, an instruction to suspend the first storage function or the second storage function to the first storage node or the at least one of the plurality of second storage nodes based on a result of the comparison.

9. The method of claim 8, wherein each of the first storage function and the second storage function is a de-duplication function, a triplication function, a caching function, a RAID function, a remote copying function, or an in-system copying function.

10. The method of claim 8, wherein the first storage function or the second storage function is a caching function, which is suspended in response to the instruction to suspend.

11. The method of claim 8, wherein the first storage function is a triplication function and the method further comprising:
receiving, by the first storage node, the instruction to suspend the triplication function, which accesses a volume in each of the plurality of second storage nodes;
suspending, by the first storage node, the triplication function;
assigning a primary indicator to a volume in one of the plurality of second storage nodes; and
directing read access or write access to the volume in the one of the plurality of second storage nodes.

12. The method of claim 8, wherein the first storage function and the second storage function are identified based on association information that indicates the first storage node is configured to apply the first storage function to the virtual volume and the at least one of the plurality of second storage nodes is configured to apply the second storage function to the volume.

13. The method of claim 8, wherein the first storage function is a triplication function and the second storage function is a de-duplication function, which is suspended in response to the instruction to suspend.

14. The method of claim 8, wherein the first storage function is a triplication function and is suspended in response to the instruction to suspend, and the method further comprising:
determining that volumes in the plurality of second storage nodes are configured to operate in two or more tiers comprising a first tier of performance and a second tier of performance, which is higher than the first tier of performance;
assigning a primary storage to a volume in one of the plurality of second storage nodes associated with the second tier of performance upon a determination that the triplication function uses the primary indicator; and
directing read access or write access associated with the second tier of performance to the primary storage.

15. A computer program for a management server in communication with a first storage node and a plurality of second storage nodes, comprising:
code for comparing a first storage function and a second storage function; and
code for sending an instruction to suspend the first storage function or the second storage function to a first storage node or at least one of a plurality of second storage nodes based on a result of the comparison;
wherein the first storage node is configured to provide a virtual volume and apply the first storage function to the virtual volume; and
the plurality of second storage nodes is configured to provide a volume to the first storage node, the volume provides storage capacity to the virtual volume provided by the first storage node, and the at least one of the plurality of second storage nodes is configured to apply the second storage function to the volume.
